(19) United States
(12) Patent Application Publication
(10) Pub. No.: US 2025/0015341 A1
(43) Pub. Date: Jan. 9, 2025

(54) THIN SULFIDE-BASED SOLID-STATE ELECTROLYTES VIA SPRAY DEPOSITION

(71) Applicant: UCHICAGO ARGONNE LLC, Chicago, IL (US)

(72) Inventors: Zachary David Hood, Bolingbrook, IL (US); Colton Ginter, Bradenton, FL (US)

(73) Assignee: UCHICAGO ARGONNE LLC, Chicago, IL (US)

(21) Appl. No.: 18/219,590

(22) Filed: Jul. 7, 2023

(51) Int. Cl. H01M 10/0562; C01D 15/00; H01M 10/0585

(52) U.S. Cl. CPC H01M 10/0562; C01D 15/00; H01M 10/0585; B05B 7/00; C01P 2002/02; C01P 2002/85; C01P 2006/40; H01M 2300/008

(57) ABSTRACT

A solid electrolyte for solid-state batteries includes a lithium argyrodite film of formula of LiₙPₓS_{y}X_{z}, where X is F, Cl, Br, I, or a mixture of two or more thereof, and where n is 1 to 10, x is 1 to 3, y is 3 to 8, and z is 1 to 3. The lithium argyrodite exhibits a polyamorphous microstructure and may have a thickness of about 1 μm to about 50 μm. The solid electrolyte is formed using spray decomposition deposition.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology relates generally to the field of solid-state lithium batteries, and more specifically is related to composite solid-state electrolytes for rechargeable batteries.

### BACKGROUND

Solid-state lithium batteries are a class of electrochemical cells that include an anode, a cathode, and a solid electrolyte sandwiched between the anode and the cathode. The solid electrolyte is an ionic conductive material. When a solid-state lithium battery is charged, lithium ions move from the cathode to the anode via diffusion through the solid electrolyte. During discharging, lithium ions move from the anode to the cathode via diffusion through the solid electrolyte.

Advantages of solid electrolytes include improved safety, lack of toxic organic solvents, low flammability, non-volatility, thermal stability, low self-discharge, and higher achievable power density. However, there are still many limitations that are hindering the large-scale adoption of solid electrolytes, due to its poor ionic conductivity compared to that of liquid counterparts and its poor mechanical stability. Furthermore, there are concerns that solid electrolytes may not be sufficiently manufacturable at industrial scale.

### SUMMARY

Issues with the ionic conductivity and mechanical stability of the solid electrolyte can be addressed by tuning the thickness of the solid electrolyte to a range of 1 micrometer (μm) to about 50 μm. However, there is a lack of scalable processes available to form solid electrolyte films in this thickness range. The present application is directed to solid electrolytes and methods of manufacturing solid electrolytes that have thicknesses that provide improved ionic conductivity and mechanical stability in a scalable fashion.

Argyrodites of formula LiₙPₓS_{y}X_{z}, wherein n is 1 to 10, x is 1 to 3, y is 3 to 8, and z is 1 to 3 (e.g., Li₆PS₅Br and Li₆PS₅Cl) have been acknowledged as promising solid electrolytes for next-generation solid-state batteries using Li metal anodes. These electrolytes hold a number of tantalizing properties, including high lithium ionic conductivity (about 10⁻⁴ S cm⁻¹), processability at temperatures less than 500° C., and compatibility with lithium metal anodes.

While the aforementioned features of argyrodites motivates their use in next-generation all-solid-state batteries, a general shortcoming of these materials is the inability to process these materials as films with thicknesses ranging from 1 μm to 50 μm, a thickness which may address issues with the ionic conductivity and mechanical stability of solid electrolytes.

In an aspect, a solid electrolyte is provided. The solid electrolyte includes a lithium argyrodite film of formula of LiₙPₓSᵥX_{z}, wherein the lithium argyrodite exhibits a polyamorphous microstructure, and X is F, Cl, Br, I, or a mixture of any two or more thereof, and wherein n is 1 to 10, x is 1 to 3, y is 3 to 8, and z is 1 to 3.

In any embodiment, the lithium argyrodite film may have a thickness of about 1 μm to about 50 μm. The lithium argyrodite film may include bridging P—S—P and terminating P—S⁻—Li⁺ bonds. The lithium argyrodite film may include thiophosphate conformations having formulas PₓS_{y}, where x is about 1 to about 3 about y is about 3 to about 8. The lithium argyrodite film may include metathiophosphate and/or thiophosphate conformations having formulas PS₄³⁻, P₂S₆⁴⁻, P₂S₇⁴⁻, and PS₃⁻. The lithium argyrodite film may include spherical nanocrystallites separated by amorphous grain boundaries. The lithium argyrodite film may exhibit an ionic conductivity greater than 10⁻⁶ S/cm. The lithium argyrodite film may have a thickness of about 10 μm to about 20 m.

In another aspect, a method of making a solid electrolyte is provided. The method includes heating a substrate at a temperature of about 25° C. to about 300° C. to form a heated substrate; and spraying a precursor solution onto the heated substrate to form a film of a lithium argyrodite having a formula of LiₙPₓS_{y}X_{z}, where X is F, Cl, Br, I, or a mixture of any two or more thereof, and wherein n is 1 to 10, x is 1 to 3, y is 3 to 8, and z is 1 to 3.

In any embodiment, the precursor solution may include a phosphorus sulfide and LiX and/or lithium sulfide dissolved in a solvent. The phosphorus sulfide may include phosphorus pentasulfide having a formula of P₂S₅, the LiX may include lithium chloride, and the solvent may include a polar protic solvent. The precursor solution may include phosphorus pentasulfide and lithium chloride present in an amount consistent with the stoichiometry of Li₆PS₅Cl, and the lithium sulfide may be present in at least 5 mol. % excess. Spraying the precursor solution may include atomizing the precursor solution. Spraying the precursor solution may include spraying the precursor solution in an argon atmosphere substantially free of oxygen and water. The method may further include curing the film of lithium argyrodite at the temperature of the substrate for about 2 minutes to about 30 minutes. The temperature of the substrate may be about 100° C. to about 300° C.

In another aspect, a solid-state battery is provided. The solid-state battery includes a cathode comprising a cathode active material; an anode comprising lithium metal; an electrolyte disposed between and in physical contact with the cathode and the anode; where the electrolyte comprises a film of polyamorphous lithium argyrodite having a thickness of about 1 μm to about 50 μm.

In a further aspect, a solution is provided. The solution includes ethanol; phosphorus pentasulfide; lithium sulfide; and LiX, where X is F, Cl, Br, I, or a mixture of any two or more thereof. The phosphorus pentasulfide and LiX are present in an amount consistent with the stoichiometry of lithium argyrodite, and the lithium sulfide is present in at least a 5 mol. % excess. The phosphorus pentasulfide, LiX, and lithium sulfide are dissolved in ethanol to saturation.

### BRIEF DESCRIPTION OF THE DRAWINGS

FIG. 1 is an illustration of possible thiophosphate bonding motifs in lithium argyrodite films.

FIG. 2 is an illustration of a spray decomposition deposition apparatus for depositing lithium argyrodite films.

FIG. 3 is a flow chart illustrating a method of spray decomposition deposition.

FIG. 4 is a schematic of a solid-state lithium battery with a lithium argyrodite solid electrolyte.

FIGS. 5A-5F are deconvolutions of X-ray photoelectron spectroscopy (XPS) spectra of lithium argyrodite films deposited with spray decomposition deposition at different temperatures.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Disclosed herein are solid-state inorganic electrolytes for solid-state electrochemical cells and processes for fabricating these inorganic electrolytes. The inorganic electrolytes include lithium argyrodite films fabricated using spray decomposition deposition. The lithium argyrodite has a formula of LinPxSyXz, where X is F, Cl, Br, I, or a mixture of any two or more thereof, and where n is 1 to 10, x is 1 to 3, y is 3 to 8, and z is 1 to 3. The lithium argyrodite may have a formula of Li₆PS₅X. The lithium argyrodite may include a stoichiometric excess of lithium in relation to the sulfur content in the lithium argyrodite. For example, the excess may be at least 5%.

The lithium argyrodite may exhibit a polyamorphous microstructure. The polyamorphous microstructure may be a fully amorphous material, or may be a mixed glass-ceramic material. Preferably, the mixed glass-ceramic material exhibits an amorphous microstructure matrix. For example, the amorphous matrix may be about 20% to about 100% of the lithium argyrodite (e.g., about 20%, 30%, 40%, 50%, 60%, 70%, 80%, or 90%). The amount of amorphous character in the lithium argyrodite may be directly related to the temperature of spray decomposition deposition of the lithium argyrodite. The amorphous character of the lithium argyrodite arises at processing temperatures of about 150° C. to about 250° C. Furthermore, a post-annealing step of the samples may increase the crystallinity at temperatures above 250° C.

The lithium argyrodite may include nanocrystalline domains. The size of the crystallites in the nanocrystalline domains may be inversely related to the temperature of spray decomposition deposition of the lithium argyrodite, with decreasing nanocrystalline size at higher temperature. The nanocrystallites may have a spherical shape and be separated by amorphous grain boundary regions.

The amorphous regions of the lithium argyrodite may include thiophosphate chains. The thiophosphate chains may include those with the formula PₓS₂ₓ₊₁. The thiophosphate chains may include bridging P—S—P bonds and/or more complex amorphous thiophosphate units. The more complex units may be present in argyrodites formed at higher temperatures. Continuous thiophosphate chains are characterized by the presence of sulfur bridges of P—S—P.

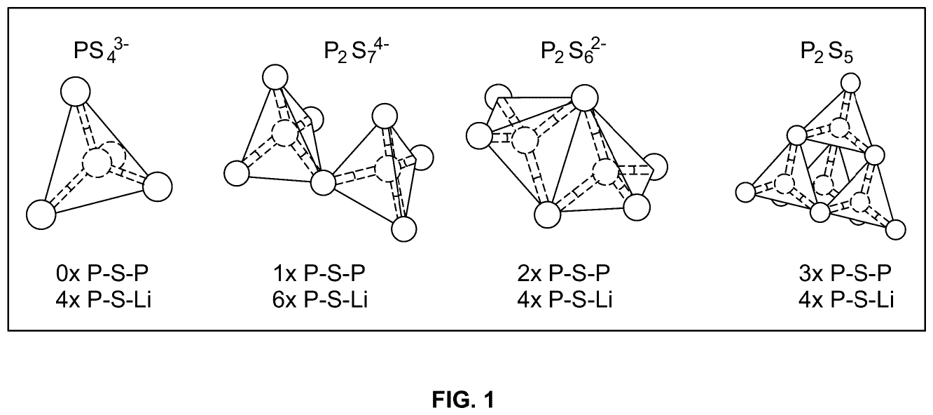

FIG. 1 is a non-limiting illustration of possible polyamorphous thiophosphate bonding motifs in lithium argyrodite films. The lithium argyrodite films may include one or more different thiophosphate motifs PₓS_{y}. For example, the thiophosphate motifs may include PS₄³⁻, P₂S₆⁴⁻, P₂S₇⁴⁻, P₂S₅, PS₃⁻, or P₂S₆²⁻. The thiophosphate motifs exhibit different combinations of bridging P—S—P and terminating P—S⁻—Li⁺ bonds. PS₄³⁻ is an orthothiophosphate without any P—S—P bridging bonds and with four P—S⁻—Li⁺ bonds. P₂S₆⁴⁻ is a hypothiophosphate with one P—S—P bridging bonds and with six P—S⁻—Li⁺ bonds. P₂S₇⁴⁻ is a pyrothiophsophate with two P—S—P bridging bonds and with four P—S⁻—Li⁺ bonds. P₂S₅ includes three P—S—P bridging bonds and four P—S⁻—Li⁺ bonds. Thiophosphate networks with a greater fraction of bridging bonds (e.g., P₂S₆²⁻ or P₂S₆⁴⁻) distribute a smaller negative charge, which may change ionic conductivity. The type of bonding motifs in the lithium argyrodite may change with changing substrate temperature during spray decomposition deposition. In an embodiment, the lithium argyrodite motifs include P₂S₆⁴⁻ and PS₄³⁻ tetrahedra.

For reference, Li₆PS₅Cl in its crystalline phase exhibits cubic symmetry, with a face-centered cubic (FCC) Cl⁻ lattice. Thiophosphate (PS₄³⁻) tetrahedra occupy all octahedral sites, and Li⁺ is trapped in cages between the PS₄³⁻.

Lithium argyrodite films may be deposited at temperatures of about 25° C. to about 300° C. With increasing deposition temperature, there is an accompanying increase in the presence of the P₂S₆⁴⁻ motif and a reduction in P—S⁻—Li⁺ bonds. Lithium argyrodite films deposited at temperatures greater than 100° C.-300° C. may exhibit a lack of crystalline phases. For example films deposited at temperatures of about 110° C., 115° C., 120° C., 125° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C. may lack crystalline phase.

The thickness of the lithium argyrodite films may be equal to or less than 50 μm. In any embodiment, the thickness of the lithium argyrodite film may be about 1 μm to about 50 μm. For example, the thickness of the film may be about 5 μm to 40 μm, 10 μm to 40 μm, 10 μm to 20 μm, or 8 μm to 15 μm (e.g., 8 μm, 10 μm, 14 μm, 15 μm, 20 μm, 25 μm, 30 μm, 35 μm, or 40 μm). The thickness of the lithium argyrodite film may be tuned by changing its deposition temperature.

The ionic conductivity of the lithium argyrodite film may be greater than 10⁻⁶ S cm⁻¹ at room temperature (i.e., 18° C. to 28° C. or 25° C.). In any embodiment, the lithium argyrodite may have an ionic conductivity of about 0.05 mS cm⁻¹ to about 5 mS cm or about 0.5 mS cm⁻¹ to about 5 mS cm⁻¹. For example, the ionic conductivity of the lithium argyrodite may be about 0.05 mS cm, 0.5 mS cm⁻¹, 1 mS cm⁻¹, 2 mS cm⁻¹, 3 mS cm⁻¹, 4 mS cm⁻¹, or 5 mS cm⁻¹.

The lithium argyrodite film may be a dense, smooth film with high interfacial contact with the substrate upon which the film is deposited. The lithium argyrodite film may have a high degree of mechanical flexibility.

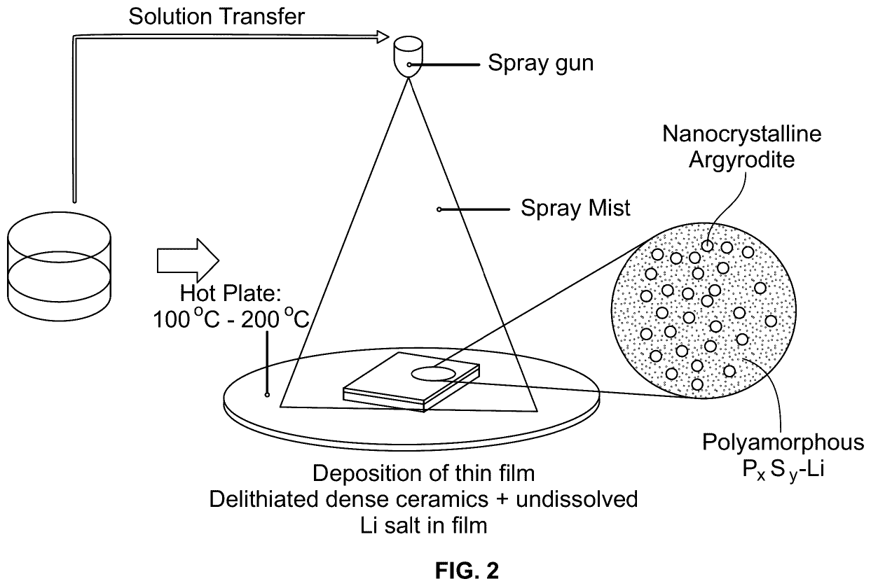

FIG. 2 is an illustration of a spray decomposition deposition apparatus for depositing lithium argyrodite films. The lithium argyrodite film is deposited on a substrate, which is heated by a heating element. The apparatus includes a spray nozzle to spray one or more precursor solutions from a precursor source onto the substrate. The spray nozzle produces a spray mist of precursor solution and may include a spray gun and/or an aerator.

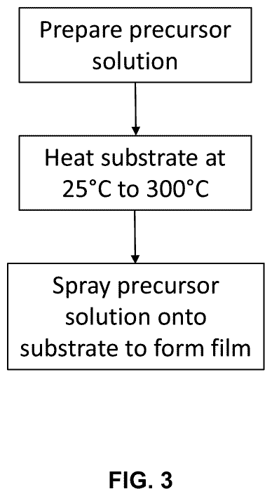

FIG. 3 is a flow chart illustrating a method of spray decomposition. The method of preparing the lithium argyrodite film may include providing a substrate, heating the substrate, preparing one or more precursor solutions, and, while heating the substrate, contacting the substrate with the one or more precursor solutions to deposit the film. As the precursor solution contacts the heated substrate, the precursor decomposes to form the film. After forming the film, the film may optionally be cured for a period of time to decompose the precursors further and post-anneal the film to obtain a crystalline film. The film may be further annealed at temperature of about 100° to about 1000° C. to obtain crystalline films. The spray decomposition apparatus and process are highly scalable for depositing lithium argyrodite films at different scales. This method also deposits films with a high contact area with the substrate. All processing and storage steps may be conducted under an argon atmosphere (e.g., in a glovebox) substantially without the presence of oxygen or water.

Characteristics of the deposited lithium argyrodite film may be selected by changing the parameters used for deposition. Characteristics that may be selected include the relative elemental composition of the film, the types and amounts of different thiophosphate bonding motifs in the film, the relative amorphous and crystalline character in the film, the presence and size of crystallite regions in the film, the thickness of the film, and the surface roughness of the film. Parameters that may be adjusted to change these characteristics include the substrate temperature during spraying, the substrate temperature during curing, the curing time, type and number of precursor solutions, the spray rate, and the spray volume. These parameters are discussed in more detail as follows.

Heating the substrate may include heating the substrate at a temperature of 25° C. to about 300° C. In any embodiment, the substrate may be heated at a temperature of about 100° C. to about 200° C. For example, the substrate may be heated at a temperature of about 25° C., 100° C., 110° C., 115° C., 120° C., 125° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C. The substrate may be heated using any suitable heating method, such as using a resistive heater.

Higher substrate temperatures and fast deposition processes increase the amount of amorphous phase in the deposited film. Exposing to the deposited film to high enough temperatures for long enough crystallizes the deposited film from an amorphous phase to a crystalline phase, forming a glass-ceramic. Without being bound by any theory this may be due to the length of exposure at high temperature providing sufficient kinetic energy so that the deposited film rearranges into a thermodynamically favorable structure. Using a lower deposition temperature and a faster deposition time increases amorphous character in the deposited film.

The deposited film may exhibit a partially polyamorphous microstructure at lower substrate temperatures (e.g., 100° C. to 125° C.). At lower temperatures, the deposited film is a mixed glass-ceramic with crystalline impurity regions due to incomplete reaction surrounded by amorphous regions. Crystallite size is inversely related to substrate temperature. Furthermore, at higher substrate temperatures, (e.g., 175° C. to 200° C.), the deposited film includes a greater amount of amorphous character and nanocrystalline regions. The deposited film includes a greater number of polyamorphous thiophosphate units, including bridging P—S—P bonds and more complex amorphous thiophosphate units. With increasing substrate temperature, there is an accompanying increase in the presence of both P₂S₆⁴⁻ and reduction in P—S⁻—Li⁺ bonds in the deposited film. Higher substrate temperatures may reduce solvent impurities from the precursor solution in the deposited film. For example, if the precursor solution includes ethanol solvent, heating the substrate at a temperature greater than 150° C. reduces the presence of ethanol impurity in the deposited film.

After the film is deposited, it may be cured to advance decomposition of the precursor solution. The substrate temperature during curing may be the same temperature used during the step of spraying or may be different. The substrate temperature during curing may be about 25° C. to about 300° C. For example, the substrate may be heated at a temperature of about 25° C., 100° C., 110° C., 115° C., 120° C., 125° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C. The length of time for curing the film may depend on the size of the film, and may vary from about 1 minute to about 60 minutes (e.g., 5 minutes, 10 minutes, 20 minutes, 30 minutes, or 60 minutes). A color change may accompany precursor degradation that is useful for determining the length of curing (e.g., a yellow precursor solution becomes white with more complete reaction).

The type and number of precursor solutions may change the characteristics of the deposited film. In some embodiments, a single precursor solution is used. The precursor solution may include a mixture of a phosphorus precursor, a chloride precursor, and a sulfide precursor, where the chloride precursor and sulfide precursor also serve as lithium precursors. The phosphorus precursor may be P₂S₅. The chloride precursor may be LiCl. The sulfide precursor may be Li₂S. In some embodiments, the ratio of precursors in the mixed precursor solution may correspond to the stoichiometry of the desired deposited film. In other embodiments, the mixed precursor solution may include an excess of lithium concentration to counter lithium sublimation during deposition and/or to create a lithium-rich film. The concentration of the precursors in the solution may be about 0.001 M to about 0.1 M (e.g., about 0.005 M, 0.008 M, 0.01 M, 0.05 M, or 0.08 M). The precursor solution or solutions may be saturated solutions. In other embodiments, more than one precursor solution is used, where each precursor solution includes one, two, or three precursors, and the precursor solutions may be sprayed sequentially or concurrently to deposit the film.

The solvent may include a substituted or unsubstituted C1 to C20 alcohol, a substitute or unsubstituted C1 to C20 ester, a substituted or unsubstituted C1 to C20 carbonate, a substituted or unsubstituted C1 to C20 ketone, or water. The solvent may be a polar protic solvent. The solvent may be a substituted or unsubstituted C1 to C6 alcohol (e.g., methanol or ethanol). The substrate temperature during spraying is at or higher than the boiling point of the solvent. The boiling point of the solvent may be 0° C. to 225° C. (e.g., 20° C. to 150° C. or 20° C. to 90° C.).

The spray rate and spray volume can be chosen to select a film thickness and film surface roughness, given a desired film area. The thickness of the film can be tuned by adjusting the total volume of precursor solution sprayed onto the substrate, with greater amounts of precursor solution sprayed resulting in thicker films. The spray rate may be about 0.1 milliliters per minute (mL/min) to about 10 mL/min (e.g., about 1.5 mL/min to about 4 mL/min, about 2 mL/min, about 2.5 mL/min, or about 3 mL/min). The precursor solution may be atomized in an even spray using an air compressor or other source. The spray of the precursor may have a uniform density and composition.

The substrate may include any suitably inert oxide material or a cathode for a solid-state lithium battery. Suitably inert oxide materials include silica glass, silicon oxide, aluminum oxide, magnesium oxide, calcium oxide, yttrium oxide, zirconium oxide, and yttrium-stabilized zirconium oxide. The solid-state cathode materials are described in more detail below.

Also disclosed are solid-state electrochemical cells with the inorganic electrolytes described above and processes for creating these electrochemical cells. An electrochemical cell includes a cathode, an anode, and an inorganic electrolyte disposed between and in physical contact with the cathode and the anode.

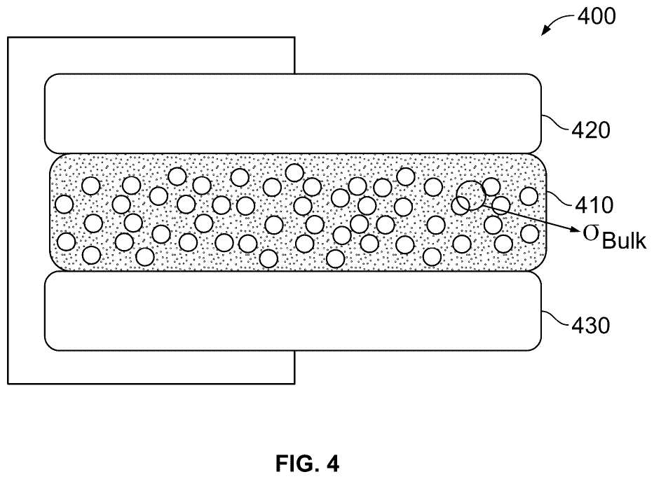

FIG. 4 is a schematic of a solid-state lithium battery 400 with a lithium argyrodite solid electrolyte 410. The lithium argyrodite solid electrolyte 410 was deposited with spray decomposition deposition according to the present application, resulting in a polyamorphous film having the properties disclosed in the present application. The lithium argyrodite solid electrolyte 410 is sandwiched between a cathode 420 and an anode 430.

The cathodes include one or more cathode active materials. Illustrative cathode active materials may include, but are not limited to, a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni₁₋₃O₂, LiMn₂O₄, LiFeO₂, LiM⁴_{0.5}Mn_{1.5}O₄, Li₁₊ₓ—Ni_{α}Mn_{β}Co_{γ}M⁵_{δ}·O_{2-z″}F_{z″}, or VO₂. In the cathode active materials, M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; 0≤x≤0.3; 0≤y≤0.5; 0≤z≤0.5; 0=x″≤0.4; 0≤α≤1; 0≤β≤1; 0≤γ≤1; 0≤δ′≤0.4; and 0≤z″≤0.4; with the proviso that at least one of α, β and γ is greater than 0. In some embodiments, the cathode includes LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCoPO₄F, Li₂MnO₃, LisFeO₄, and Li_{x′}(Met)O₂, wherein Met is a transition metal and 1<x′≤2. In some embodiments, Met is Ni, Co, Mn, or a mixture of any two or more thereof. In some embodiments, Met is a mixture of Ni, Co, and Mn. In some embodiments, the cathode active material may include LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCoPO₄F, Li₂MnO₃, Li₅FeO₄, or Li_{x′}(Met)O₂, where Met is a transition metal and 1<x′≤2. Other materials may include metallic or semiconducting particles, or plasmonic particles that generate nascent electric fields when irradiated by white light. In some embodiments, the cathode may include a cathode active material that includes manganese. In such embodiments, the cathode active material may include, but is not limited to LiMn_{0.5}Ni_{0.5}O₂, LiMn_{1/3}Co_{1/3}Ni_{1/3}O₂, LiMn₂O₄, LiM⁴_{0.5}Mn_{1.5}O₄, Li_{1+x″}Ni_{α}Mn_{β}Co_{γ}M⁵_{δ′}O_{2-z}F_{z″}, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiMnPO₄, or Li₂MnO₃, where M⁴ is Al, Mg, Ti, B, Ga, Si, Mn, or Co; M⁵ is Mg, Zn, Al, Ga, B, Zr, or Ti; 0≤x″≤0.4; 0≤α≤1; 0≤β≤0; 0≤γ≤1; 0≤δ′≤0.4; 0≤z″≤0.4; and 0≤n′≤3. Example cathode materials include, but are not limited to, LiFePO₄, LiFeₓMn₁₋ₓPO₄ (0≤x≤1), and LiNiₓMn_{y}Co_{1-x-y}O₂ (NMC, 0<x≤1, 0<y≤1, 0≤x+y≤1).

Illustrative anode materials include metallic anode active materials such as lithium, sodium, or magnesium; sulfur materials; metal oxides such as TiO₂ or Li₄Ti₅O₁₂; or carbon materials including, but not limited to, synthetic graphite, natural graphite, amorphous carbon, hard carbon, soft carbon, mesocarbon microbeads (MCMB). In any of the above embodiments, the anode may include a graphite material, alloys, intermetallics, silicon, silicon oxides, TiO₂ and Li₄Ti₅O₁₂, and composites thereof. For example, the anode active material may include a metallic anode material intercalated within a host material, where the metallic anode material includes, but is not limited to, lithium, sodium, or magnesium, and the host material may be an active carbon material including, but not limited to, synthetic graphite, natural graphite, amorphous carbon, hard carbon, soft carbon, mesocarbon microbeads (MCMB). In other embodiments, the metallic anode material includes, but is not limited to, lithium, sodium, or magnesium, and metallic anode material is dispersed in a host material, which may be an alloy, intermetallic, silicon, silicon oxide, TiO₂, Li₄Ti₅O₁₂, or mixtures of any two or more thereof. In some embodiments, the anode active material is a lithiated carbon material such as lithiated graphite. Example anode materials for the lithium battery include, but are not limited to, Li metal, meso-carbon microbeads, natural graphite, synthetic graphite, soft carbon, hard carbon, and Si-based alloys.

The inorganic electrolyte, cathodes, and/or anodes of the lithium batteries may also include one or more conductive additives. In some embodiments, the conductive additive may be a conductive carbon. Examples of conductive carbons include synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, and/or graphene.

The lithium batteries may also include current collectors. Current collectors for the anode and/or the cathode may include those of copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys.

The anodes and cathodes may include one or more binders that bind the electrode active material and other materials in the electrode to the current collector. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatin, a copolymer of any two or more such polymers, or a blend of any two or more such polymers.

The present invention, thus generally described, will be understood more readily by reference to the following examples, which are provided by way of illustration and are not intended to be limiting of the present invention.

### EXAMPLES

Spray decomposition deposition offers a route to low temperature, single step synthesis of thin film solid electrolytes. In spray decomposition deposition, a concentrated precursor solution is atomized in a low boiling temperature solvent and sprayed onto a heated substrate. The solvent, ethanol (EtOH) evaporates, and LISICON forming salts (P₂S₅ and Li₂S) decompose to form a matrix phase before the Li containing salt decomposes. The resulting film has high contact area with the substrate, and the thickness can be tuned by adjusting the volume of spray solution. The film is composed of nanocrystalline argyrodite nuclei and large disordered grain boundary regions containing thiophosphate chains of the formula PₓS₂ₓ₊₁.

In this work, purely amorphous lithium argyrodite film electrolytes, with thicknesses ranging from 10-40 μm, were synthesized using spray decomposition deposition. Verification of amorphous glass was conducted by X-Ray Diffraction (XRD), and transport properties were studied in solid state symmetric cells by Electrochemical Impedance Spectroscopy (EIS). Ex situ X-ray Photoelectron Spectroscopy (XPS) and X-Ray Absorption Spectroscopy (XAS) were conducted to determine the bonding, coordination, and interphase composition in the deposited film.

### Methods

Ethanol (EtOH) was selected as a precursor, and a stoichiometric combination of P₂S₅ (Arcos Organics, >98%) and LiCl (Sigma Aldrich, >99.0%), alongside 5 mol. % excess Li₂S (Sigma Aldrich, 99.98%) were dissolved to saturation. The resulting precursor solution, hereby referred to as the spray solution, was determined to be 0.079 M.

The substrate was placed on a steel plate on a hot plate, then preheated until an infrared gun confirmed the desired temperature. Solutions were sprayed at a rate of 2 mL/min onto the substrate with an atomizer. Substrate temperatures were set from 100° C.-200° C. in 25° C. intervals. All processing and storage steps were conducted under an argon atmosphere in a glovebox.

The film was characterized with X-ray diffraction (XRD), scanning electron microscopy (SEM), X-ray photoelectron spectroscopy (XPS), X-ray absorption spectroscopy (XAS), and electrochemical impedance spectroscopy (EIS).

Complete decomposition of crystalline precursor was determined using XRD from 2θ=5° to 80° with Cu Kα (λ=1.5406 Å) on a Bruker D8 MRD. Films were sprayed onto a glass substrate, then sealed with a Kapton film before analysis.

Surface and cross-sectional images of spray decomposition deposition films sprayed onto C—Al sheets were taken via SEM at 1000× magnification using a Phenom XL at 10 kV bias.

XPS analysis was conducted with samples mounted on a glass substrate using a 180-degree hemispherical analyzer (ThermoFisher K-Alpha+) with an Al anode (Al-kα, hv=1486.7 eV). All samples were ion beam etched to obtain depth profiles and remove any surface oxidation. Normalization was conducted using adventitious carbon C1s set to 284.8 eV

XAS studies were conducted on the Sulfur K-edge at beamline ID-9-BM of the Advanced Photon Source. Scans were referenced to a fully crystalline sample synthesized by conventional solid-state processing. Analysis and data correction were conducted with the Demeter Suite24.

Solid state symmetric cells were assembled with argyrodite films acting as solid electrolytes. Argyrodite films were sprayed onto copper sheets, where the copper sheets acted as electrodes. Electrochemical Impedance Spectroscopy was conducted on a VSP-300 (Biologic) from 7 Hz to 1 MHz with a 100 mV bias between −20° C. and 100° C.

### Results and Discussion

Spray decomposition deposited films were synthesized using 5 mL of 0.0078 M EtOH precursor solution, sprayed at a rate of 2.5 mL/min onto glass slides. After the spraying process was complete, the films were allowed to cure for 5 minutes at steady state, until the films turned completely white—an indicator that Li₂S had decomposed. The films were then sealed using Kapton, and analyzed with XRD.

XRD revealed that the deposited films formed spherical nanocrystallites, separated by amorphous grain boundaries formed from the initial matrix phase. The amorphous phases may contain continuous thiophosphate chains. Films synthesized at temperatures greater than 125° C. lacked any crystalline peaks in the XRD spectra, indicating the presence of amorphous phases in the films.

SEM imaging confirmed the formation of dense, smooth films with high interfacial contact with the substrate. Film thicknesses were measured with cross-sectional SEM imaging, revealing a thickness of 8±0.3 μm for films synthesized at 200° C. and 14.2±0.2 μm at 150° C. At higher substrate temperatures, the Leidenfrost effect was observed, resulting in crater formations on the surface. Films exhibited a high degree of mechanical flexibility.

XPS spectra for films deposited at substrate temperatures of 100° C., 125° C., 150° C., and 175° C. were collected. Crystalline reference material manufactured by conventional solid-state processing was also collected for comparison.

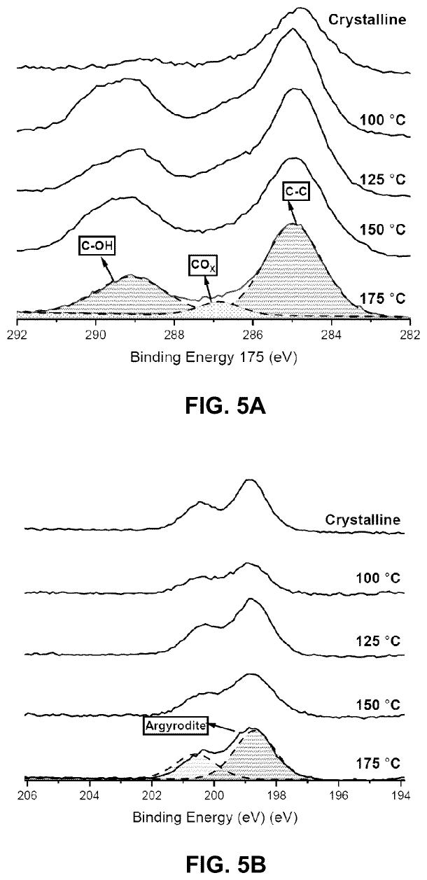

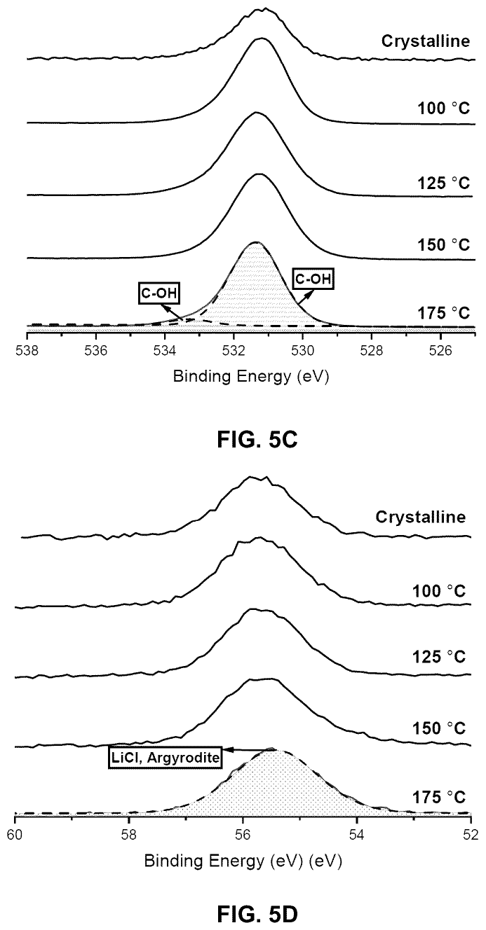

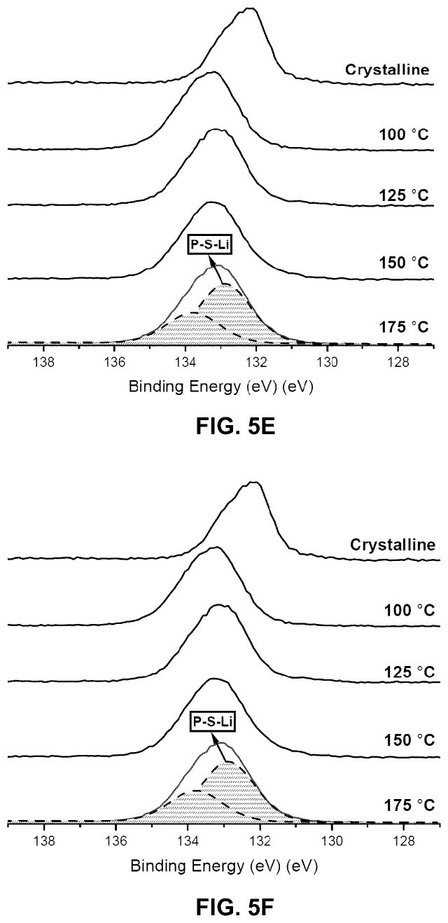

FIGS. 5A to 5F show XPS data for argyrodite films deposited at different temperatures, as compared to a crystalline argyrodite film. FIG. 5A shows XPS spectra for C 1s peaks for argyrodite films deposited at different temperatures, as compared to a crystalline argyrodite film. FIG. 5B shows XPS spectra for Cl 2p peaks for argyrodite films deposited at different temperatures, as compared to a crystalline argyrodite film. FIG. 5C shows O 2s peaks for argyrodite films deposited at different temperatures, as compared to a crystalline argyrodite film. FIG. 5D shows Li 1s peaks for argyrodite films deposited at different temperatures, as compared to a crystalline argyrodite film. FIG. 5E shows P 2p peaks for argyrodite films deposited at different temperatures, as compared to a crystalline argyrodite film. FIG. 5F shows S 2p peaks for argyrodite films deposited at different temperatures, as compared to a crystalline argyrodite film.

The deconvolution of the XPS data in FIGS. 5A to 5F were compiled to determine ratios of peak area for S2p spectra. The crystalline argyrodite film had 6.1% Li₂S fraction, 62.1% P—S⁻-Li+ fraction, and 31.8% P—S—P fraction. The lithium argyrodite film deposited at 100° C. had 6.8% Li₂S fraction, 8.2% P—S⁻—Li⁺ fraction, 56.5% P—S—P fraction, 20.0% P₂S₆ fraction, and 8.5% sulfite. The lithium argyrodite film deposited at 125° C. had 4.6% Li₂S fraction, 35.5% P—S⁻—Li⁺ fraction, 31.5% P—S—P fraction, 25.3% P₂S₆ fraction, and 3.1% sulfite. The lithium argyrodite film deposited at 150° C. had 12.1% Li₂S fraction, 23.9% P—S⁻—Li⁺ fraction, 44.2% P—S—P fraction, 14.4% P₂S₆ fraction, and 5.3% sulfite. The lithium argyrodite film deposited at 175° C. had 8.8% Li₂S fraction, 35.2% P—S⁻—Li⁺ fraction, 24.6% P—S—P fraction, 27.2% P₂S₆ fraction, and 4.2% sulfite

Deconvolution of the Li Is, P 2p, and Cl 2p spectra confirmed the formation of argyrodite. Relevant peaks at 55.4 eV, 132.9 eV, and 198.7 eV were indicative of LiPSCl. However, the Li Is may also be attributed to the precursor LiCl.

There was a shift in the P 2p peak in the XPS spectra in the crystalline LiPSCl as compared to the spray deposited LiPSCl. A general shift to higher binding energies was observed in spray deposited LiPSCl, which, without being bound by any theory, may be a result of a) the lithium excess present in relation to sulfur and/or b) the formation of polyamorphous thiophosphate units. Configurations of PₓS_{y}, detailed in FIG. 1, exhibit differing combination of bridging P—S—P and terminating P—S⁻—Li⁺ bonds. Thiophosphate networks with a greater fraction of bridging bonds (Meta-, Hypo-) distribute a smaller negative charge, such that the electron density around P increases, and binding energy of the core shell is reduced. As a result, slight shifts in the phosphorous peaks in XPS spectra are expected, but are too slight to accurately deconvolute.

A similar process was attempted with the S 2p XPS spectra. Deconvolution showed some differentiation between P—S bonding motifs, including peaks matching the expected P—S—Li ending groups, and higher binding energy electrons indicative of P₂S₆⁴, which distributes a greater charge across each sulfur anion compared to PS₃⁻ (−2/3 vs. −1/3 e). With increasing temperature, there was an accompanying increase in the presence of both P₂S₆⁴⁻ and reduction in P—S⁻—Li⁺ bonds. The possibility of other bridging thiophosphate units, including polymerized PS₃⁻ networks cannot be determined. The XAS spectra indicated a shift towards higher energies in samples synthesized at high temperatures, indicative of a decrease in sulfur's local electron density. This feature can be accounted for by a greater coordination with positively charged Li⁺, supporting the possibility that more P—S⁻—Li⁺ bonds are present.

Additionally, the sulfur K-Edge spectra bore a broad peak centered at 2473 eV, associated with increased scattering in the second and third coordination shell. The broadening in the peak increased substantially with temperature, as indicated by samples synthesized at 175° C. and 200° C. In the all-amorphous films deposited at higher temperatures, the absorption edge at 2468.8 eV was reduced in intensity and higher in binding energy to 2469.7 eV. No Li₂S or radical polysulfides were detected, however, they may exist beneath the limits of the XAS experiment, as suggested by the detection of Li₂S by XPS.

Electronic and ionic conductivities of spray decomposition deposited films were determined by EIS, using symmetric cells composed of a copper sheet onto which a Li₆PS₅Cl film was deposited via spray decomposition deposition at a substrate temperature of 200° C. Utilizing thickness measurements obtained by SEM, it was determined that the ionic conductivity of the Li₆PS₅Cl film was on the order of 1 mS cm⁻¹.

In conclusion, a dense, non-crystalline argyrodite electrolyte film with a thickness of 10 μm to 20 μm was synthesized using spray decomposition deposition. Spray decomposition deposition is shown to bypass the inherent thickness limitations of spray pyrolysis, and results in multiple amorphous thiophosphate modifications as a polymorphic argyrodite.

The electronic and bonding structure of argyrodite films indicated that higher temperature spray decomposition deposition favors the formation of P₂S₆⁴⁻ and individual PS₄³⁻ tetrahedra. An increase in local electron density was confirmed by XAS, alongside loss of the clear absorption edge, indicating the isolated thiophosphates observed in crystalline argyrodite were not present. Increases in multiple scattering events indicated the formation of extended PS₃⁻ networks.

EIS experiments indicated that polyamorphous argyrodite films deposited via spray decomposition deposition had sufficient ionic conductivity for solid state battery applications. That is, the polyamorphous argyrodite films had an ionic conductivity in excess of 10⁻⁵ S cm⁻¹.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A solid electrolyte comprising:
a lithium argyrodite film of formula of LiₙPₓS_{y}X_{z} and exhibiting a polyamorphous microstructure,
wherein X is F, Cl, Br, I, or a mixture of any two or more thereof; and
wherein n is 1 to 10, x is 1 to 3, y is 3 to 8, and z is 1 to 3.

2. The solid electrolyte of claim 1, wherein the lithium argyrodite film has a thickness of about 1 μm to about 50 μm.

3. The solid electrolyte of claim 1, wherein the lithium argyrodite film comprises bridging P—S—P and terminating P—S⁻—Li⁺ bonds.

4. The solid electrolyte of claim 1, wherein the lithium argyrodite film comprises thiophosphate conformations having formulas PₓS_{y} where x is 1 to 3 and y is 3 to 8.

5. The solid electrolyte of claim 1, wherein the lithium argyrodite film comprises thiophosphate conformations having formulas PS₄³⁻, P₂S₆⁴⁻, P₂S₇⁴⁻, and PS₃⁻.

6. The solid electrolyte of claim 1, wherein the lithium argyrodite film further comprises spherical nanocrystallites separated by amorphous grain boundaries.

7. The solid electrolyte of claim 1, wherein the lithium argyrodite film exhibits an ionic conductivity greater than 10⁻⁶ S/cm.

8. The solid electrolyte of claim 1, wherein the lithium argyrodite film has a thickness of about 10 μm to about 20 μm.

9. The solid electrolyte of claim 1, wherein X is Cl.

10. A method of making a solid electrolyte, the method comprising:
heating a substrate at a temperature of about 25° C. to about 300° C. to form a heated substrate; and
spraying a precursor solution onto the heated substrate to form a film of a lithium argyrodite having a formula of LiₙPₓS_{y}X_{z}, wherein X is F, Cl, Br, I, or a mixture of any two or more thereof, and wherein n is 1 to 10, x is 1 to 3, y is 3 to 8, and z is 1 to 3.

11. The method of claim 10, wherein the precursor solution comprises a phosphorus sulfide and LiX and/or lithium sulfide dissolved in a solvent.

12. The method of claim 11, wherein the phosphorus sulfide comprises phosphorus pentasulfide having a formula of P₂S₅, the LiX comprises lithium chloride, and the solvent comprises a polar protic solvent.

13. The method of claim 12, wherein the precursor solution comprises phosphorus pentasulfide and lithium chloride present in an amount consistent with stoichiometry of Li₆PS₅Cl, and the lithium sulfide is present in at least 5 mol. % excess.

14. The method of claim 10, wherein spraying the precursor solution comprises atomizing the the precursor solution.

15. The method of claim 10, wherein spraying the precursor solution comprises spraying the precursor solution in an argon atmosphere substantially free of oxygen and water.

16. The method of claim 10, further comprising curing the film of lithium argyrodite at the temperature of the substrate for about 2 minutes to about 30 minutes.

17. The method of claim 10, wherein the film of lithium argyrodite has a thickness of about 1 μm to about 50 μm.

18. The method of claim 10, wherein the film of lithium argyrodite has a polyamorphous microstructure.

20. A solid-state battery comprising:
a cathode comprising a cathode active material;
an anode comprising lithium metal;
an electrolyte disposed between and in physical contact with the cathode and the anode; and
wherein the electrolyte comprises a film of polyamorphous lithium argyrodite having a thickness of about 1 μm to about 50 μm.
